(19) United States
(12) Patent Application Publication
(10) Pub. No.: US 2026/0129091 A1
(43) Pub. Date: May 7, 2026

(54) SYSTEMS AND METHODS FOR SYNCHRONIZING DATA ACROSS MULTIPLE NODES

(71) Applicant: Blue Origin, LLC, Kent, WA (US)

(72) Inventors: Tom Abeles, Seattle, WA (US); Phillip Burger, Ramona, CA (US); Alex Miller, Federal Way, WA (US); Holly Deuterman, Seattle, WA (US); Hiteksha Patel, Parker, CO (US); Justin Chmura, Phoenix, AZ (US); Anson Foong, Redmond, WA (US); Josh Spradling, Peoria, AZ (US)

(21) Appl. No.: 18/939,253

(22) Filed: Nov. 6, 2024

(51) Int. Cl. H04L 67/1095

(52) U.S. Cl. CPC H04L 67/1095

(57) ABSTRACT

A system comprising a ground-based station comprising a first data store, where the first data store stores operational characteristics of a space-based station, where the space-based station comprises a second data store that mirrors the first data store at a first time. The ground-based station is configured to generate first log data based on a determined type of activity performed by the user at a second time. The system further comprises a user device located on the space-based station and configured to determine a second type of activity performed by the user at the space-based station at the second time; generate second log data based on the determined second type of activity performed by the user; process a synchronization request received from the ground-based station; identify a conflict between the first and second data logs; and in response to identifying the conflict, select one of the data logs are accurate.

### BACKGROUND

Computing devices can utilize communication networks to exchange data between nodes in a terrestrial environment and space-based environment. Commercial and international organizations operate computer networks that interconnect a number of computing devices to support operations or to provide services to third parties (such as in-situ resource utilization, scientific experimentation, and mining operations). The computing devices can be located in a single geographic location, located in multiple, distinct geographic locations (e.g., interconnected via private or public communication networks), or in a space-based environment.

### SUMMARY

The systems, methods, and devices described herein each have several aspects, no single one of which is solely responsible for its desirable attributes. Without limiting the scope of this disclosure, several non-limiting features will now be discussed briefly.

One aspect of the disclosure provides a system comprising a ground-based station comprising a first processor and a first data store, where the first data store stores operational characteristics of a space-based station that is capable of operating in space, where the space-based station comprises a second data store that mirrors the first data store at a first time, where computer-executable instructions, when executed by the first processor, cause the ground-based station to: determine a type of activity performed by a user at a space-based station at a second time after the first time via a first detection system; and generate first log data based on the determined type of activity performed by the user. The system further comprises a user device with a second processor and memory, where the user device is associated with the space-based station, and where second computer-executable instructions, when executed by the second processor, cause the user device to: determine a second type of activity performed by the user at the space-based station at the second time via a second detection system different than the first detection system; generate second log data based on the determined second type of activity performed by the user; process a synchronization request received from the ground-based station, where the synchronization request includes the first log data; identify a conflict between the first and second data logs, where the conflict corresponds to differences of a data element value made by each the ground-based station and the space-based station in respective data stores; and in response to identifying the conflict, select between the first data log and the second data log based on a condition being satisfied to resolve the conflict.

The system of the preceding paragraph can include any sub-combination of the following features: where the second computer-executable instructions, when executed by the second processor, further cause the user device to process the synchronization request received from the ground-based station when the space-based station is within a threshold communication distance with the ground-based station; where the second computer-executable instructions, when executed by the second processor, further cause the user device to select between the first data log and the second data log as the accurate value based on the first condition and the second condition, where the first condition and the second condition each correspond to timestamps of log data, causal consistency between log data, semantic policies regarding log data, priority rules of log data, arithmetic operations of log data, communication capabilities of stations, location of stations, predicted location of stations according to geosynchronous orbit; where the second computer-executable instructions, when executed by the second processor, further cause the user device to generate a data replica associated to a spacecraft, where the spacecraft comprises a third data store, where the data replica is configured to mirror data from the first and second data store; where the second computer-executable instructions, when executed by the second processor, further cause the user device to track usage of assets corresponding to the activity with an image-based data management technique to obtain usage data of the assets.

Another aspect of the disclosure provides a computer implemented method, under control of a user device with a processor and memory, where the user device is located on a first station, and where computer-executable instructions, when executed by the processor, cause the user device to perform steps of: determining a type of activity performed by a user at a first station via a detection system; generating first log data based on the determined type of activity performed by the user; processing a synchronization request received from a second station, where the synchronization request includes second log data; identifying a conflict between the first and second log data, where the conflict corresponds to differences of a data element value made by each the first station and the second station in respective data stores; and in response to identifying the conflict, selecting between the first data log and the second data log as an accurate value to resolve the conflict.

The computer implemented method of the preceding paragraph can include any sub-combination of the following features: where processing the synchronization request received from the second station comprises processing the synchronization request received from the second station when the first station is within a threshold communication distance with the second station; where selecting between the first data log and the second data log as the accurate value comprises selecting between the first data log and the second data log as the accurate value based on the first condition and the second condition, where the first condition and the second condition each correspond to a data management policy; where the method further comprises generating a data replica associated to a third station, where the third station comprises a third data store, where the data replica is configured to mirror data from the first and second data store; where determining the type of activity performed by the user at the first station comprises determining the type of activity performed by the user at the first station via a sensor and determining the type of activity performed by the user at the second station via monitoring a video feed; where selecting between the first data log and the second data log as the accurate value to resolve the conflict comprises selecting between the first data log and the second data log as the accurate value to resolve the conflict by merging the first data log and the second data log; where selecting between the first data log and the second data log as the accurate value to resolve the conflict by merging the first data log and the second data log further comprises selecting between the first data log and the second data log as the accurate value to resolve the conflict by merging the first data log and the second data log according to a conflict-free replicated data type (CRDT) technique; where selecting between the first data log and the second data log as the accurate value to resolve the conflict comprises selecting the first log data based on a first condition or selecting the second log data based on a second condition.

Another aspect of the disclosure provides a non-transitory, computer-readable medium comprising computer executable instructions, where the computer-executable instructions, when executed by a computer system, cause the computer system to: determine a type of activity performed by a user at a first station via a detection system; generate first log data based on the determined type of activity performed by the user; process a synchronization request received from a second station, where the synchronization request includes second log data; identify a conflict between the first and second log data, where the conflict corresponds to differences of a data element value made by each the first station and the second station in respective data stores; in response to identifying the conflict, select between the first data log and the second data log as an accurate value to resolve the conflict.

The non-transitory, computer-readable medium can include any sub-combination of the following features: where processing the synchronization request received from the second station comprises processing the synchronization request received from the second station when the first station is within a threshold communication distance with the second station; where selecting between the first data log and the second data log as the accurate value comprises selecting between the first data log and the second data log as the accurate value based on the first condition and the second condition, where the first condition and the second condition each correspond to data management policy; where the computer-executable instructions further include instructions, when executed by a computer system, cause the computer system to generate a data replica associated to a third station, where the third station comprises a third data store, where the data replica is configured to mirror data from the first and second data store; where determining the type of activity performed by the user at the first station comprises determining the type of activity performed by the user at the first station via a sensor and determining the type of activity performed by the user at the second station via monitoring a video feed; where selecting between the first data log and the second data log as the accurate value to resolve the conflict comprises selecting between the first data log and the second data log as the accurate value to resolve the conflict by merging the first data log and the second data log according to a conflict-free replicated data type (CRDT) technique; where selecting between the first data log and the second data log as the accurate value to resolve the conflict comprises selecting the first log data based on a first condition or selecting the second log data based on a second condition.

### BRIEF DESCRIPTION OF DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure. To easily identify the discussion of any particular element or act, the most significant digit(s) in a reference number typically refers to the figure number in which that element is first introduced.

FIGS. 1A-1B illustrate example data synchronization environments in accordance with the disclosure herein.

FIG. 2 illustrates an example data synchronization system in accordance with the disclosure herein.

FIGS. 3A-3B illustrate example data flow interactions depicting data synchronization as described in examples herein.

FIG. 4 illustrates an example routine for data synchronization in accordance with the disclosure herein.

FIG. 5 illustrates a block diagram of an illustrative computing system configured to synchronize data according to some embodiments.

### DETAILED DESCRIPTION OF SPECIFIC EMBODIMENTS

The present disclosure relates to efficient computing resource usage for synchronizing data between remote systems by managing changes to data locally and merging received changes according to data management policies. Advantageously, synchronizing the remote systems includes resolving data conflicts in an efficient manner (e.g., automated identification and resolution of conflicts between remote stations in ground-based and space-based environments) allowing for greater data management efficiency than conventional data synchronization methods. Achieving greater data management efficiency can be especially impactful between remote systems syncing log data from, for example, ground-based and space-based environments (e.g., a ground-based and space-based stations each monitoring activities of users in space), which reduces time spent identifying and resolving data conflicts in environments with limited communication capabilities.

In some approaches, synchronizing data between remote systems—such as ground-based and space-based stations—occurs by comparing and updating datasets. Space-based stations, for example, update datasets according to activities occurring in the space station, including data for personnel activities and parameters, inventory, and station diagnostic parameters. Concurrently, ground-based stations monitor the activity remotely via remote sensor systems and personnel observations and update ground-based datasets according to observed activities. At a later time, the stations synchronously update the datasets. In this way, the space-based station transmits the datasets associated with the activities to the ground-based station. The ground-based station reviews the space-based data and compares with the ground-based data. Comparing the datasets may include potentially comparing millions of data elements to identify conflicts. When the ground-based station identifies a conflict, the system then determines which of the datasets is accurate and updates a central database accordingly. After resolving the conflicts, the ground-based station then transmits updated datasets to the space-based station. This can be problematic due to a short, finite time window in which the stations are able to communicate with each other given the respective orbits and Earth's rotation. If the stations require multiple time windows to complete a data synchronization, this can delay critical ground or space-based operations. In some cases, space-based operations may be incapable of performance until the data synchronization is complete. For example, personnel in a space-based station may request to ground control for a spacewalk to perform maintenance on the station. Ground control may need to verify parts for the maintenance are accessible and able to be used by the personnel. Until the ground control can verify the parts are accessible, the personnel will wait until verification is complete. In this way, the process to identify and resolve conflicts is inefficient and prone to errors.

By transmitting and receiving entire datasets, the stations must be in a state of constant communication to transfer datasets. Having the stations in constant communication may be impractical in some situations, such as when the space-based station is outside a threshold communication distance with the ground-based station or when the space-based station lacks direct line of sight with the ground-based station. Further, comparing datasets with a central database in a synchronous manner may lead to a single point of failure, bottleneck in communicating updates, and latency. For example, when the central data base acts as a central authority, the central server is responsible for maintaining the main version of the data set. The other nodes seek to synchronize with the central server. In this way, the central server may risk being a single point of failure for all the nodes. If the central server goes down, no updates can be made or retrieved by any node, halting the entire system. Further, the central server may act as a bottleneck for updating the data set. In this way, all nodes communicate with the central server for updates. For example, when an update occurs by one node, each other node communicates with the central server to access the updates. Finally, communicating with the central server may lead to varying degrees of latency. For example, each interactions requires a round-trip to the central server for providing the update and receiving confirmation. In this way, each update takes time to transmit, process, and obtain confirmation. In some cases, the nodes may be moving across low-Earth orbit increasing the round trip time and potentially delaying communication such that the node is outside of a communication threshold distance.

Some aspects of the present disclosure address some or all of the issues noted above, among others, by efficiently synchronizing data between remote systems by managing changes to data and merging received changes according to data management policies asynchronously. The stations each may have data replicas stored in the respective data store. The data replicas may include data structures (may also be referred to herein as “data replicas” and/or “data elements”) corresponding to assets managed at the stations locally or remotely. When activities occur that may change parameters of the assets, the stations update log data to chronicle the changes to the assets. The stations each monitor activities occurring locally (or remotely) to obtain log data about changes in response to the activities and store the log data to the data store. Due to the remote nature of the stations, there may be conflicts with observed activities and log data between each of the stations. Each of the stations may make changes to a same data element in different data replicas, each station having a different data replica. When the stations initiate data synchronization, the systems managing data at the respective stations identifies and resolves conflicts between the log data for each of the stations. The systems determine which of the log data satisfies a condition, and updates the local data store. In this way, stations interacting obtain current log data for the activities observed (and conflicts resolved) between the remote stations. In some cases, the systems disclosed herein use a conflict-free replicated data type (CRDT) for synchronizing data between the remote stations.

Additional aspects of the present disclosure relate to managing data transfer between nodes. Nodes may include any system capable of monitoring data. For example, nodes may include a space-based station, ground-based station, spacecraft, satellite, or another system capable of monitoring data. Managing nodes, for example, may include adding data structures for a node, removing data structures for a node, and updating data structures for nodes. In some examples, a spacecraft (as a new node) may be set to launch from the ground-based station. The spacecraft may include assets for which to monitor data, such as personnel, inventory, and spacecraft diagnostic parameters for monitoring by the spacecraft and the ground-based station. To ease tracking of data generated by the spacecraft and other nodes relevant to the spacecraft, the ground-based station generates a data structure for a new node. The data structure for the new node can include data with respect to the assets of the node (for example, an initial state of the assets for the spacecraft). In some examples, the generation of the data structure for the new node may include generating a replica or copy of the data of the assets of the new node stored by the ground-based station and storing the replica or copy in a data store associated with the new node. The replica or copy of the data of the assets of the new node may be associated with a particular time or version. In this way, the ground-based station and the spacecraft may monitor activity from a common initial data state (e.g., from the replica or copy of the data of the assets of the node associated with the particular time or version).

By monitoring the activity from the data replica, the stations and/or nodes that perform data synchronization may reduce computing resource usage (e.g., reduce network bandwidth usage, reduce processing power usage, reduce memory usage, etc.), reduce time spent communicating between various stations and/or nodes, and increase the accuracy of the tracking of the activity being monitored.

In some cases, starting from a common initial data state reduces computing resource usage by reducing the amount of data transferred between nodes. For example, reducing the amount of data transferred reduces the network bandwidth needs for each of the systems communicating updates. Having reduced data sizes correspondingly reduces the bandwidth requirements of transmitting the data packets, thereby reducing computing resource usage. Additionally, reducing the amount of data transferred allows for fewer processing cycles to merge data associated to the updates. Fewer processing cycles allows for the associated systems to provide greater computing resources for other productive tasks. Further, reducing the amount of data transferred allows for increased memory accessibility for other programs and applications. For example, decreasing the data transferred provides more memory access to other programs and applications.

In some cases, starting from a common initial data state reduces time spent communicating between various stations and/or nodes due to fewer data packets transmitted and received by each of the systems. Communication data packets transmitted and received are proportional to a size of the updates to the data replica. By reducing the size of the updates due to tracking updates from the initial data state, the systems reduce the data packets transmitted, thereby decreasing the time spent communicating the updates.

In some cases, starting from a common initial data state increases the accuracy of tracking the monitored activity due to decreased complexity for auditing changes. Starting from the common initial data state allows the systems to monitor changes to the initial data state according to the activity, rather than updating an entire data set. In some cases, when the data replicas are in different data states, monitoring the activity can lead to inaccurate results. For example, some tools in space-based environments have a limit on the number times personnel may use the tools. When the nodes start from different data states, or are unaware of the number of times the tools have been used prior, the monitored activity of a tool may be inaccurate and even dangerous to the personnel. In this case, the tool might have reached the limit for use, but the inaccurate systems monitoring the activity may be unaware of the tool reaching the limit and allow the personnel to continue.

Various aspects of the disclosure will now be described with regard to certain examples and embodiments, which are intended to illustrate but not limit the disclosure. Although aspects of some embodiments described in the disclosure will focus, for the purpose of illustration, on particular examples of data synchronization, computational resources, data replicas, and conflict resolution, the examples are illustrative only and are not intended to be limiting. In some embodiments, the techniques described herein may be applied to additional or alternative computing environments, computing resources, processing units, data synchronization, data replicas, and conflict resolution, and the like. Additionally, any feature used in any embodiment described herein may be used in any combination with any other feature or in any other embodiment, without limitation.

### Example Data Synchronization Environments

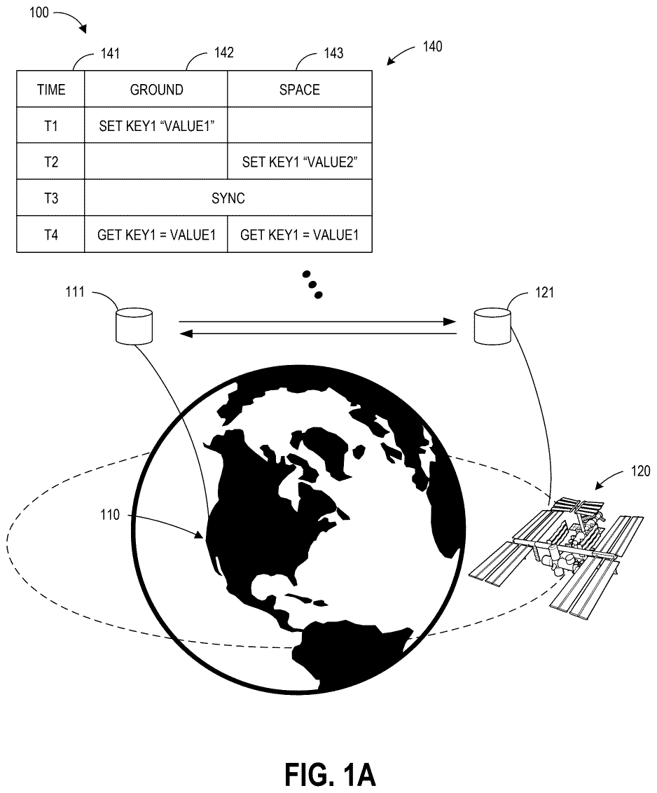

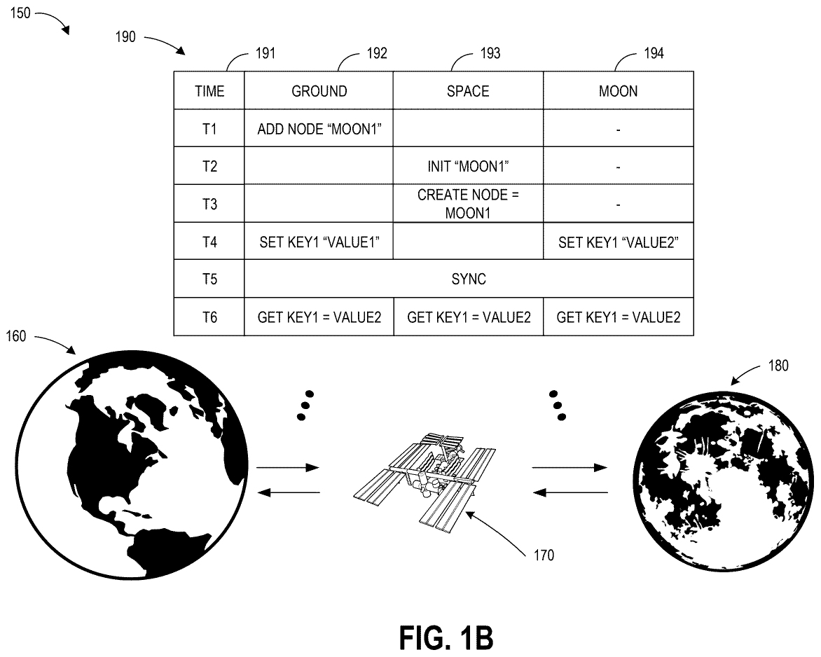

FIGS. 1A and 1B illustrate example environments of ground-based and space-based stations synchronizing remote data stores. Synchronizing data between space-based and ground-based stations presents significant technological challenges. For example, the space-based station must obtain data in a harsh environment with extreme temperatures, radiation, and limited power supply. The space-based station may use various systems to monitor activities of the station. For example, the space-based station may rely on manual or automated systems to collect data regarding the activities. In some cases, the manual system may include personnel preparing documents (written or electronic) including information related to the space-based activities. The ground-based station may also rely on manual or automated systems to collect data regarding the same activities. For example, the ground-based station may monitor the activities via video feed monitoring and update documents (written or electronic) accordingly. However, syncing the stations data stores may face challenges due to the remote nature of the stations. For example, communication between the space-based and ground-based stations is subject to inconsistent communication channels (as oftentimes a line of sight signal may be necessary), latency, and interruptions due to the vast distance and potential obstacles, such as atmospheric interference and physical obstructions. Moreover, ensuring data integrity and security during transmission presents challenges, as any loss or corruption of data can lead to inaccurate synchronization.

FIG. 1A depicts an environment 100 including a ground-based station 110 with a space-based station 120 orbiting. In some examples, both stations independently monitor activities occurring at the space-based station 120 and update respective data replicas stored in data stores 111, 121. For example, personnel of the space-based station may be performing a spacewalk by exiting the space-based station 120 to perform maintenance. As shown with respect to various times, a table 140 includes a time column 141, a ground column 142 (representative of actions by the ground-based station 110), and a space column 143 (representative of actions by the space-based station 120). At a first time, a system of the ground-based station 110 sets a value locally, updating the first data store 111. For example, a ground-based system may classify activity of the personnel as a spacewalk via video feed monitoring and identify tools used by the personnel by manual observation of the video monitoring. The ground-based system may automatically (or by manual technique) update a value that may represent a number of times a particular tool is used by the personnel performing maintenance. For example, the ground-based station 110 may observe the tool used one time (shown in FIG. 1A with “VALUE 1” in column 142). In this way, the tool may have a limit to the number of uses before being retired for use. At a second time, a system of the space-based station 120 also sets a value for the same data element locally, updating the second data store 121. For example, the personnel selecting the tool may result in a sensor monitoring the tool to trigger a status flag, indicating the tool is used. In this way, the space-based station 120 may observe the tool used two times (shown in FIG. 1A with “VALUE 2” in column 143). The space-based system updating the value of the data element results in a conflict with the value updated by the ground-based system due to the independent updates by both stations. However, due to each station being remote and without having synchronized data at this time, the stations are unaware of the conflict. At a third time, when the data stores 111, 121 of each station synchronize, the systems face the challenge of determining which of the conflicting data values is accurate. This determination is made based on which of the conflicting data values satisfies a condition. The condition may be according to a predefined data management policy, which is robust enough to handle discrepancies and prioritize data accurately. When the accurate value is identified, the systems set the data element to the accurate value and update the data stores 111, 121. The update ensures that both the ground-based station 110 and space-based station 120 obtain the current data without conflicts. At a fourth time, both stations 110, 120 request the value of the data element. The data stores 111, 121 each return the accurate value, ensuring that the data provided is up-to-date and reflective of the latest synchronization.

FIG. 1B depicts an environment 150 where a ground-based station 160 seeks to obtain data from a moon-based station 180, yet lacks direct communication capabilities with the moon-based station 180. In this way, the ground-based station 160 communicates with a space-based station 170 as a gateway. As shown with respect to various times, a table 190 includes a time column 191, a ground column 192 (representative of actions by the ground-based station 160), a space column 193 (representative of actions by the space-based station 170), and a moon column 194 (representative of actions by the moon-based station 180). At a first time, the ground-based station 160 requests a data replica of a node representative of the moon-based station 180 to access log data. At a second time, the space-based station 170, acting as the gateway, initializes the node for the moon-based station 180 to access to the data replica. In this way, the space-based station 170 is within a first threshold distance to the ground-based station 160 and within a second threshold distance to the moon-based station 180. At a third time, the space-based station 170 generates a data replica of the moon-based station 180. At a fourth time, challenges arise as both the ground-based station 160 and the moon-based station 180 independently set a value for the same data element locally, updating respective data replicas. In this way, updating data elements creates a conflict between the values of the data element. At a fifth time, the data synchronization process begins, involving the ground-based, space-based, and moon-based stations 160, 170, 180. The systems each determine which of the conflicting data values is accurate, relying on a predefined data management policy as disclosed herein. When the accurate value is identified, the systems set the data element to the accurate value and update the data replicas. The update ensures that all stations involved are synchronized with the current data. At a sixth time, the ground-based station 160, the space-based station 170, and the moon-based station 180 return the value of the data element. The systems efficiently return the value to each station, ensuring that the data provided is up-to-date and consistent. In this way, the system manages communication delays, ensures data retrieval speeds, and ensures the data remains consistent across the stations despite the vast distances and potential for communication disruptions.

### Example Data Synchronization System and Data Flow

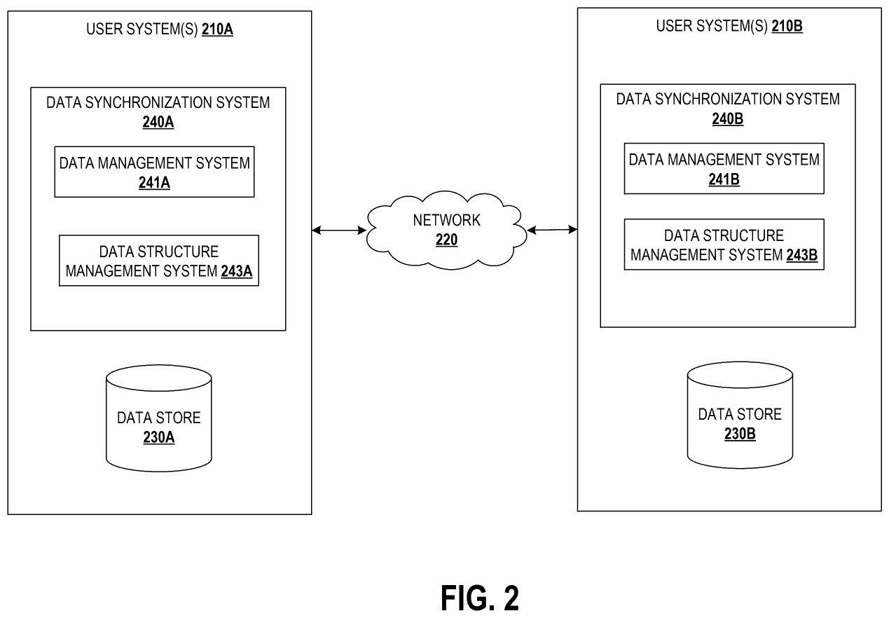

FIG. 2 illustrates an example data synchronization system in which aspects of the present disclosure may be implemented. In some examples, as shown, the network environment may include any number of user systems 210A and 210B and a network 220. The user systems 210A and 210B each include a data store 230A, 230B and a data synchronization system 240A, 240B. The data synchronization system 240A, 240B further includes a data management system 241A, 241B and a data structure management system 243A, 243B. The network enables communication between the user systems 210A, 210B.

The user systems 210A, 210B may include various types of systems which may interact with the data stores 230A, 230B to manage data elements. For example, the user systems 210A, 210B may include personal computing devices (such as desktops, laptops, and mobile communication devices), satellites, ground-based stations (e.g., Earth-based and inter-planetary stations, such as the moon), space-based stations, and spacecraft. In some examples, the user systems 210A, 210B may update data elements in response to activity by, or at, one of the user systems 210A, 210B. The activity may include actions taken by personnel impacting inventory at the user system 210A, 210B. For example, the personnel may interact with a tool, drink water, eat food, move supplies, among other actions, with which the interactivity is monitored.

The data stores 230A, 230B may store operational characteristics of the user systems 210A, 210B. In some examples, the operational characteristics may include data replicas of data corresponding to monitored activity for each respective user system 240A, 240B. In some examples, the data stores 230A, 230B may be located at one of the user systems 210A, 210B. For example, one of the data stores 230A, 230B may be located within a ground-based station, space-based station, moon-based station, or another station to store data.

The data synchronization systems 240A, 240B may synchronize data across the data stores 230A, 230B. The data synchronization systems 240A, 240B may include several sub-components that operate to synchronize data and resolve conflicts. The sub-components may include a data management systems 241A, 241B and a data structure management systems 243A, 243B.

The data management systems 241A, 241B may perform several functions to monitor, manage, and synchronize data efficiently. In some examples, the data management systems 241A, 241B may monitor data corresponding to each node connected to the network 220. For example, each node may represent a distinct data source, such as the user systems 210A, 210B (e.g., ground-based stations, space-based stations, or moon-based stations). The data management systems 241A, 241B may keep a real-time check on the data generated and modified at the nodes, ensuring that any changes are promptly recorded and tracked. The data management systems 241A, 241B may receive log data from these nodes. The log data may include detailed records of asset updates (such as inventory tracking, station performance, personnel information, etc.). By analyzing the log data, the data management systems 241A, 241B may identify patterns, detect anomalies, and recognize any potential conflicts between data values at different nodes. The log data may serve as an audit trail, allowing the data management systems 241A, 241B to identify any discrepancies to a source (such as the data replica, predicted activity results, and/or actual asset usage). When the data management systems 241A, 241B identifies conflicting values for data elements from the log data, the data management systems 241A, 241B may trigger a conflict resolution process. For example, the data management systems 241A, 241B may resolve the conflicting log data by determining which log data satisfies a condition. When the accurate data value is determined, the data management systems 241A, 241B proceed to update the data stores 230A, 230B with the accurate data value.

In some examples, the data management systems 241A, 241B may handle communications and data transmissions according to communication constraints. For example, the communication constraints may include latency, signal bandwidth, communication signal strength, among other communication constraints. In some examples, the data management systems 241A, 241B may prioritize data transfer based on communication factors. For example, the communication factors may include priority of data (or log data), timestamp of the log data, type of user system 210A, 210B, among other factors. In this way, the data management systems 241A, 241B may communicate with respect to the priority of data, while de-escalated priority data can be scheduled for later communication during communication windows. The prioritization may assist in managing resources of the network 220 effectively and may ensure that data remains consistent and up-to-date. Priority may correspond to an impact to the user systems 210A, 210B. For example, the impact may be associated to personnel health and safety, system performance, communication channel activity, emergency situations, among other impacts to the user systems 210A, 210B. In some cases, priority may relate to an order with which to communicate information. For example, the priority may correspond to a first node, a second node, and a third node communicating. The first node may receive a request to synchronize data from the second node and then the third node. In this situation, the second node has greater priority than the third node in communicating with the first node.

The data management systems 241A, 241B may manage data conflicts for the user systems 210A, 210B. In some examples, data conflicts arise when the user systems 210A, 210B update data replicas and identify a data element has different values, for example, a first data element value provided by user system 210A and a second data element value provided by user system 210B. The different values for the same data element may arise in different data replicas when the user systems 210A, 210B may make a mistake in activity observation.

The data management systems 241A, 241B may resolve the data conflict when detected. The data management systems 241A, 241B may resolve the conflict according to satisfying a condition of the log data with respect to data management policies to select the accurate value. The policies may include various factors that influence data priority and accuracy. For example, the factors may include: a time of reception, priority of source of the log data, type of station, time associated with updating data elements, amount of bandwidth available for transmission, and/or identifier associated with the data element. In some cases, the data management systems 241A, 241B may prioritize the data value based on the time the data was received. For example, more recent data may be given higher priority as the more recent data is likely to be more current. In some cases, the data management systems 241A, 241B may evaluate the source of the log data. Log data received from stations where the activity may have elevated priority. For example, if an activity occurs in space, data from space-based stations may have elevated priority over data from ground-based stations. In some cases, the data management systems 241A, 241B may consider the type of station reporting the data. Different types of stations, such as ground-based, space-based, or moon-based stations, may have different levels of reliability and priority. In some cases, the data management systems 241A, 241B may review the timestamp associated with the data updates. Data with more recent timestamps may be preferred over older data. In some cases, the data management systems 241A, 241B may consider the available bandwidth for transmitting data. Data conflicts might be resolved differently based on the network bandwidth capacity, ensuring efficient use of network resources. In some cases, the data management systems 241A, 241B may take into account the latency involved in transmitting the data. Data from sources with lower latency might be given higher priority as they are less likely to be outdated. In some cases, the data management systems 241A, 241B may consider unique identifiers (such as alpha-numeric values, password-protected data, communication protocol elements, etc.) associated with data elements to cross-reference and validate data elements. After determining the accurate value, the data management systems 241A, 241B may update the data element of the data replica.

The data structure management system 243A, 243B may manage data structures for the user systems 210A, 210B. For example, the data structure management system 243A, 243B may manage addition and removal of nodes connected to the user systems 210A, 210B. In some examples, the data structure management system 243A, 243B may add a node. In this way, the data structure management system 243A, 243B may generate a data structure for the node. For example, the data structure may include a data replica mirroring the data replicas in the data stores 230A, 230B. The data structure may grant access to the new node to interact with the connected nodes. In this way, the new node may monitor data, store data and log data, update data and log data, and resolve conflicts, among other tasks associated with managing data. In some examples, the data structure management system 243A, 243B may generate the data structure to include data from other nodes. For example, the generated data structure may also include data elements from other nodes already connected to the user systems 210A, 210B. In this way, the generation of the data structure ensures the new node has access to relevant data for operations. In some examples, the data structure management system 243A, 243B may remove a node. In this way, the data structure management system 243A, 243B may delete the data structure locally and/or globally. When the data structure management system 243A, 243B removes the node, the data structure management system 243A, 243B deletes the node's data replica, corresponding data, network addresses, access capabilities, among other aspects for identification and communication from the data stores 230A, 230B. In this way, the data structure management system 243A, 243B may remove data elements and references associated with the removed node, ensuring that no residual data remains that could cause inconsistencies. In response to deleting the node, the data structure management system 243A, 243B may revoke access to the data replica stored on the data store 230A, 230B from the removed node. For example, the removed node may no longer be able to read, write, or update any data with respect to the connected nodes. By removing the node and the data structure, the data structure management system 243A, 243B may ensure the other connected nodes are unable to access or update data related to the removed node.

The network 220 may be a publicly-accessible network of linked networks, possibly operated by various distinct parties, such as the Internet. In some cases, the network 220 may be or include a space-based network, optical network, a private network, personal area network, local area network, wide area network, global area network, cable network, satellite network, cellular data network, etc., or a combination thereof, some or all of which may or may not have access to and/or from the Internet. Although FIG. 2 illustrates a single network 220, the illustration is provided for purposes of example only, and is not intended to be limiting, required, or exhaustive. In some embodiments, the network 220 may include, or be in communication with, a plurality of networks. For example, the network 220 may include an internal network and a backbone network.

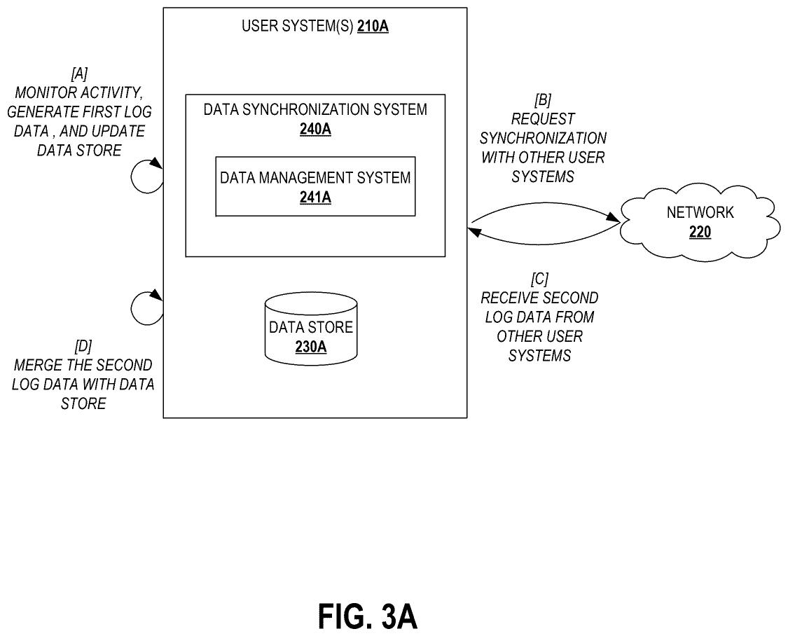

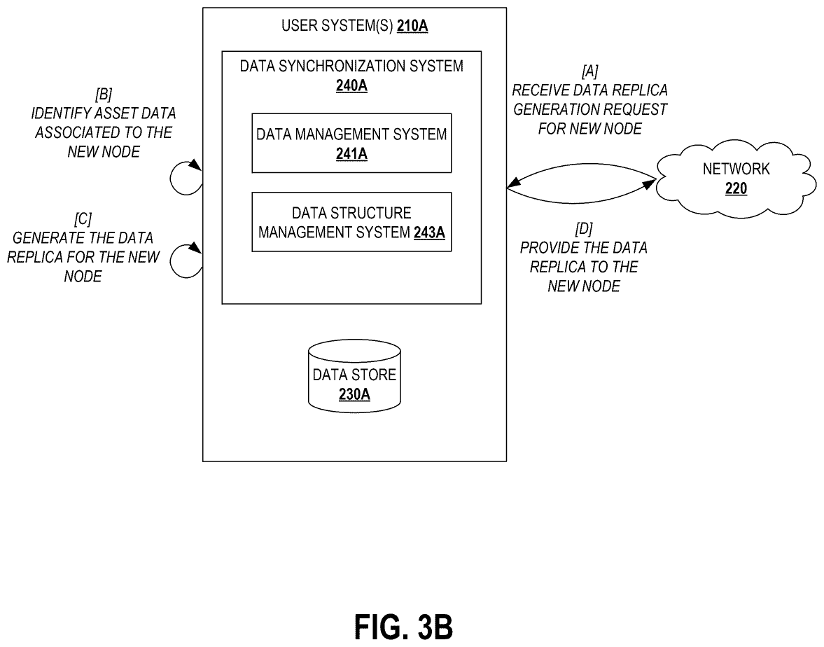

FIG. 3A is a diagram of illustrative data flows and interactions between a user system 210A and a network 220 to perform efficient data synchronization between user systems.

At [A], the user system 210A monitors activity, generates first log data corresponding to the activity, and updates the data store 230A. In some examples, the data synchronization system 240A may monitor activity occurring at the user system 210A and changes to the data elements of a data replica. For example, by interfacing with sensors and instruments to identify changes to the data elements. In some examples, the data elements of the data replica may include profiles associated to station assets (e.g., tools, food, water, etc.), station parameters (temperature, radiation levels, energy usage, etc.), personnel (e.g., physiological parameters, activity levels, etc.). In some cases, the data replica may be conflict-free replicated data types (CRDTs).

The user system 210A generates first log data corresponding to the activity. The log data may include timestamps, data values, and/or metadata about the conditions under which the data was collected, among other information related to changes to data elements. For example, obtaining data with image-based (and/or audio-or video-based) monitoring of item movement, changes regarding station assets (such as drinking water, eating food, producing waste, etc.), station parameters (such as temperature, radiation levels, system performance, etc.), and/or scientific experiment results. In some examples, the log data may include a chain of operations regarding the data element. For example, when the data element may correspond to a tool used by the personnel at the station, the tool may be used by the personnel a number of separate times. Each use of the tool may be a distinct update to the log data. In this way, the data synchronization system 240A may apply priority weighting to the various updates to the log data to determine a most recent updated value. For example, the latest update to the log data may have elevated priority as the most recent change to the data element, as compared to a prior update to the log data. In some examples, the data collection may be continuous and/or automated. For example, monitoring physiological parameters of the personnel (such as heart rate, blood oxygen, electro cardio activity, etc.) may be taken in a continuous manner. The continuous monitoring may include repeated measurements by a sensor at a set frequency to obtain physiological data of the personnel.

The user system 210A updates the data store 230A with the first log data associated to the monitored activity. In some examples, the data synchronization system 240A may update the data store 230A by storing changes to the data elements according to the monitored activity. In this way, the log data may identify changes from a baseline value (or most recent value) of the data elements. In some examples, the data replica stored in the data store 230A (or other data stores for other user systems) may be mutable or immutable. For example, when the data replica is mutable, the data synchronization system 240A (and/or the other user systems) may update the data replica. In this way, the update to the data replica may include generating a new data element and/or removing an existing data element. The data synchronization system 240A (and/or other user systems) may notify other nodes that include corresponding data replicas of the update. In some examples, the data synchronization system 240A and/or the other user systems may store a snapshot of the data (data stores, data replicas, log data, etc.). In this way, the data synchronization system 240A (and/or the other user systems) may apply the snapshot in simulations. The simulations may provide a proxy view of what the other user systems observed according to the log data.

In some examples, the data synchronization system 240A (and/or the other user systems) may monitor current log data, revisions to the log data, and changes to the log data. The current log data, revisions to the log data, and changes to the log data may each be stored in respective tables. For example, a current data table, a revisions table, and a changes table. The current data table may store current states of the data elements of the data replica for a corresponding user system that includes the current data table. The revisions table may store updates to the data elements according to resolved conflicts in the data elements, personnel changes to the data elements, or other revisions. The changes table may store changes to the data elements observed by the data synchronization system 240A (and/or other user systems). The changes may correspond to the log data.

At [B], the user system 210A requests synchronization of data with other systems. In this way, the data synchronization system 240A may update the data replica stored by the data store 230A with data obtained by other user systems. The synchronization requested by the data synchronization system 240A may provide for asynchronous updating such that the user system 210A may asynchronously obtain log data, and at a separate time, update the data store 230A with data from other user systems. By synchronizing in an asynchronous manner, the data synchronization system 240A may provide for increased efficiency in computing resource usage due to reducing energy consumption by transmitting changes to the data elements (for example, as log data) as requested, rather than entire datasets to a central database.

In some examples, the data synchronization system 240A may request a response from available nodes with a corresponding data replica. For example, the data synchronization system 240A may transmit a request for acknowledgement message to at least some nodes within a threshold communication distance. The request for acknowledgement message may include an identifier of the data replica, identifiers of known nodes, and/or an identifier of the user system 210A including the data synchronization system 240A. In this way, the nodes that receive the request for acknowledgement message may query the respective data store to determine whether the data replica exists local to the node. If the data replica exists, the node may respond to the message. The data synchronization system 240A may receive an acknowledgement response from the nodes that include a corresponding data replica. In some examples, the data synchronization system 240A and/or the other user systems may request re-synchronization. For example, if the data synchronization system 240A and/or the other user systems identify an error associated with the synchronization process. The error may include audit results including one or more data elements found to be missing from the log data provided. In this way, the data synchronization system 240A (and/or other user systems) may identify a point in time from the log data where there is the missing data element. In some examples, the data synchronization system 240A and/or the other user systems may store a last sync time. In this way, the last time sync may identify a time in which the data synchronization system 240A (and/or the other user system) updated the data store 230A (or corresponding data stores) with changes to the data replica commensurate with changes identified from the log data (first log data, second log data, etc.). In some examples, the data synchronization system 240A may include an application programming interface (API) to synchronize the data between user systems. The API may allow for POST, PUT, GET calls, among other API calls used to identify, transfer, synchronize data, among other actions.

At [C], the user system 210A receives second log data from other user systems. In some examples, the second log data may correspond to the activity at the user system 210A observed by the other user systems. For example, the other user systems may observe activity at the user system 210A (which includes the data synchronization system 240A) and update a local data store including a corresponding data replica. The other user systems may observe the activity occurring at the user system 210A with remote observation systems (for example, via an image-based monitoring system or other systems as described herein). In this way, the activity (such as personnel using a tool at the user system 210A) may be observed by the other user systems and stored as log data. The second log data may include a conflicting data element.

In some examples, the other user systems may observe activity occurring local to the other user systems and update a corresponding local data store including a data replica. The activity occurring local to the other user systems (such as consuming food or drinks at the other user systems) may be observed by the other user systems and stored as log data. In this way, the second log data may be without a conflicting data element. Even though there may be no data conflict, the log data may be of interest to the data synchronization system 240A due to the urgency with respect to personnel health and safety may be shared by the other user systems to the user system 210A. In this way, if the station with the other user system runs out of food or water, the user system 210A may rely on log data from the other user systems to support the emergency situation.

In some examples, the data synchronization system 240A may determine that data from the other user system (and/or from the data synchronization system 240A) successfully reached the target system. In some examples, the log data to synchronize between user systems may include text, images, audio and/or video, among other data types able to transmit between the user systems.

In some examples, the data synchronization system 240A may schedule communication transmission and reception based on predefined communication factors. For example, the communication factors may include a level of priority of the data element (e.g., the data synchronization system 240A may schedule high-priority data elements for immediate synchronization, while deferring lower-priority data); available communication windows (e.g., the data synchronization system 240A may schedule synchronization activities during periods when reliable communication is identified and/or predicted, and/or when latency levels are within a permissible threshold); size of the data to be transferred (e.g., the data synchronization system 240A may schedule larger log data transfers with increased priority due to the larger log data relying on increased bandwidth and increased transmission times).

At [D], the user system 210A merges the second log data with the data store 230A. When the data synchronization system 240A receives the second log data, the data synchronization system 240A may apply a merge function to integrate the updates into the data store 230A. The merge function may be commutative (for example, order of updates has no effect on merging data), associative (for example, grouping of updates has no effect on merging data), and idempotent (for example, applying the same update multiple times has the same effect as applying the update once).

In some examples, the data synchronization system 240A merging the second log data with the data store 230A may resolve conflicts. For example, the data synchronization system 240A may apply a conflict identification technique to identify conflicts. In some examples, the data synchronization system 240A may identify the conflict by comparing values of data elements associated to the data replica. For example, the data synchronization system 240A may identify the conflict as differing values for the same data element reported by different user systems. For example, a space-based station may monitor a usage of a tool when personnel perform an activity with the tool (such as performing maintenance to the space-based station) and a ground-based station may remotely monitor the activity with the tool. Each of the stations may observe the activity, but may result in differing values for the data element associated to the tool within each respective data replica. In this way, there is a conflict between the data elements associated to the tool from the space-based station and the ground-based station. When a conflict is identified, the data management system 240A may resolve the conflict.

In some examples, merging the second data log with the data store 230A may resolve the conflict by applying conflict resolution techniques. In this way, the conflict resolution techniques may apply one or more data management policies to govern resolution of conflicts. In some examples, the data management policies may correspond to various data parameters. The parameters may include one or more of timestamps (for example, temporal clocks, logical clocks, or another type of timestamp), causal consistency (operations that are causally related are seen in the correct order), semantic policies (custom merge policies can be defined based on the semantics of the data), priority rules (based on predefined criteria such as user roles or the source of the update), arithmetic operations (addition and subtraction are inherently conflict-free, and merging is done by summing the counts from different replicas), communication capabilities (latency between user systems, communication signal strength, etc.), location of the user systems, predicted location according to the geosynchronous orbit of the involved stations, and/or other parameters relevant to resolving conflicts.

FIG. 3B is a diagram of illustrative data flows and interactions between a user system 210A and a network 220 to generate a data replica for a new node.

At [A], the user system 210A receives a request for generating a data replica for a new node. In some examples, the request may be from ground-based station, an onboard computer on the spacecraft, or another space-based station. The new node may include any of the user systems as described herein. For example, the new node may be a spacecraft preparing for launch from a ground-based station, where the ground-based station transmits the request. The user system 210A may specify requirements for the data replica, which includes types of data the node may collect and how data elements of the data replica may be organized.

At [B], the user system 210A identifies asset data associated to the new node. In some examples, the asset data may correspond to the type of the user system. For example, the new node may be a spacecraft, which may house assets such as personnel, tools, food, water, fuel, among various other assets. In some examples, the user system 210A may generate a manifest listing data elements associated to the assets to include in the data replica. The manifest may include asset information associated to the data elements. For example, the asset information may include an amount of times the asset was used, an initial quantity of the asset, a baseline value of the asset (such as physiological parameters of the personnel), among other asset information relevant to the new node.

At [C], the user system 210A generates the data replica for the new node. In some examples, the user system 210A may generate the data replica according to the manifest. In some examples, the user system 210A may verify the data elements are compatible with systems of the new. At [D], the user system 210A provides the data replica to the new node.

### Example Data Synchronization Routine

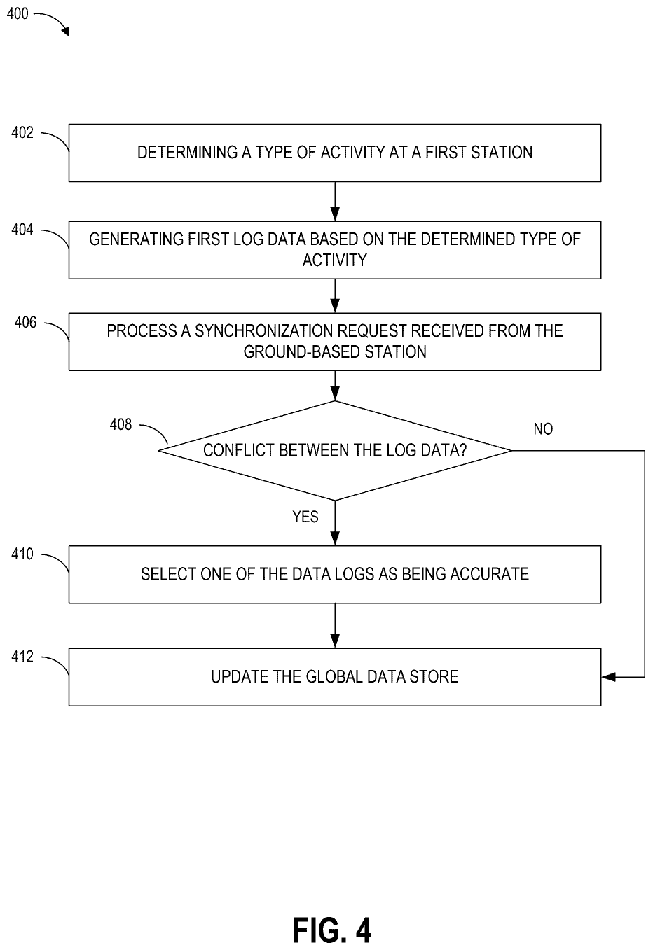

FIG. 4 is a flow diagram depicting an example data synchronization routine 400. The routine 400 may be carried out, for example, by a data synchronization system 240A of FIG. 2. The routine 400 begins at block 402, where the data synchronization system 240A determines a type of activity at a first station. In some examples, the data synchronization system 240A may monitor activity occurring at the user system 210A. For example, by interfacing with sensors and instruments to identify changes to assets associated to the data elements. In some examples, the data elements of the data replica may include profiles associated to assets (tools, food, water, etc.), station parameters (temperature, radiation levels, energy usage, etc.), personnel (physiological parameters, activity levels, etc.). In some cases, the data replica may be conflict-free replicated data types (CRDTs).

At block 404, the data synchronization system 240A generates first log data based on the determined type of activity. The data synchronization system 240A may generate the first log data according to the techniques described herein (for example, as described in [A] of FIG. 3A).

At block 406, the data synchronization system 240A processes a synchronization request received from a second station. In this way, the data synchronization system 240A may update the data replica stored by the data store 230A with data obtained by other user systems. The synchronization request may provide for asynchronous updating such that the user system 210A may asynchronously obtain log data, and at a separate time, update the data store 230A with data from other user systems. By synchronizing in a selective manner, the data synchronization system 240A may provide for increased efficiency in resource usage due to reducing energy consumption by transmitting changes to the data elements (for example, as log data) as requested, rather than entire datasets to a central database. In some examples, the data synchronization system 240A may request a response from available nodes with a corresponding data replica as described herein (for example, as described in [B] of FIG. 3A).

At block 408, the data synchronization system 240A determines whether a conflict exists between the log data. For example, the data synchronization system 240A may apply a conflict identification technique to identify conflicts. In some examples, the data synchronization system 240A may identify the conflict by comparing values of data elements associated to the data replica. For example, the data synchronization system 240A may identify the conflict as differing values for the same data element reported by different user systems. If the data synchronization system 240A identifies a conflict, the routine 400 proceeds with block 410. If the data synchronization system 240A does not identify a conflict, the routine 400 proceeds with block 412.

At block 410, the data synchronization system 240A selects one of the data logs as being accurate. The data synchronization system 240A may apply conflict resolution techniques to resolve the conflict. In this way, the conflict resolution techniques may apply one or more data management policies to govern resolution of conflicts. In some examples, the data management policies may correspond to various data parameters. The parameters may include one or more of timestamps (for example, temporal clocks, logical clocks, or another type of timestamp), causal consistency (e.g., operations that are causally related are seen in the correct order), semantic policies (e.g., custom merge policies can be defined based on the semantics of the data), priority rules (based on predefined criteria such as user roles or the source of the update), arithmetic operations (e.g., addition and subtraction are inherently conflict-free, and merging is done by summing the counts from different replicas), communication capabilities (e.g., latency between user systems, communication signal strength, etc.), location of the user systems, predicted location according to the geosynchronous orbit of the involved stations, and/or other parameters relevant to resolving conflicts.

At block 412, the data synchronization system 240A updates the data store. In some examples, the data synchronization system 240A may complete a merging of log data in response to a result of the conflict resolution.

### Example Computing Device

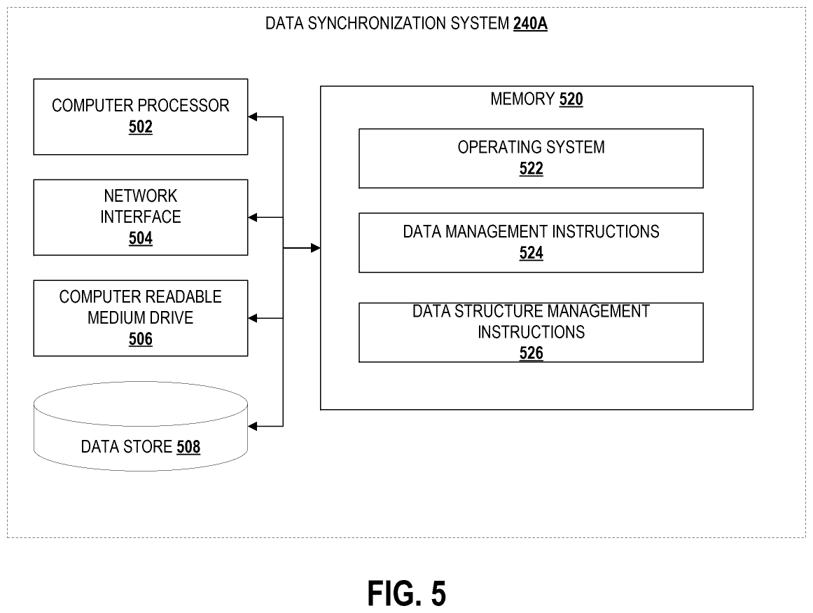

FIG. 5 illustrates various components of an example computing device configured to implement various functionality of the data synchronization system 240A. In some embodiments, as shown, the data synchronization system 240A may include: one or more computer processors 502, such as physical central processing units (“CPUs”); one or more network interfaces 504, such as a network interface cards (“NICs”); one or more computer-readable medium drives 506, such as a high density disk (“HDDs”), solid state drives (“SSDs”), flash drives, and/or other persistent non-transitory computer-readable media; one or more data store 508, such as physical storage and/or remote storage, and/or other data storage components; and one or more computer-readable memories 520, such as random access memory (“RAM”) and/or other volatile non-transitory computer-readable media. The computer-readable memory 520 may include computer program instructions that one or more computer processors 502 execute in order to implement one or more embodiments. The computer-readable memory 520 can store an operating system 522 that provides computer program instructions for use by the computer processor(s) 502 in the general administration and operation of the data synchronization system 240A. In some embodiments, the computer-readable memory 520 can further include computer program instructions and other information for implementing aspects of the present disclosure. For example, the computer-readable memory 520 may include data management instructions 524 for managing data to identify conflicts, as described herein. As another example, the computer-readable memory 520 may include data structure management instructions 526 for managing data structures, as described herein. When a routine is initiated, a corresponding set of executable program instructions stored on a computer-readable medium drive 506 may be loaded into computer-readable memory 520 and executed by one or more computer processors 502. In some embodiments, a routine—or portions thereof—may be implemented on multiple computing devices and/or multiple processors, serially or in parallel.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or logic circuitry that implements a state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements, or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system comprising:
a ground-based station comprising a first processor and a first data store, wherein the first data store stores operational characteristics of a space-based station that is capable of operating in space, wherein the space-based station comprises a second data store that mirrors the first data store at a first time, wherein computer-executable instructions, when executed by the first processor, cause the ground-based station to:
determine a type of activity performed by a user at a space-based station at a second time after the first time via a first detection system; and
generate first log data based on the determined type of activity performed by the user; and
a user device with a second processor and memory, wherein the user device is associated with the space-based station, and wherein second computer-executable instructions, when executed by the second processor, cause the user device to:
determine a second type of activity performed by the user at the space-based station at the second time via a second detection system different than the first detection system;
generate second log data based on the determined second type of activity performed by the user;
process a synchronization request received from the ground-based station, wherein the synchronization request includes the first log data;
identify a conflict between the first and second data logs, wherein the conflict corresponds to differences of a data element value made by each the ground-based station and the space-based station in respective data stores; and
in response to identifying the conflict, select between the first data log and the second data log based on a condition being satisfied to resolve the conflict.

2. The system of claim 1, wherein the second computer-executable instructions, when executed by the second processor, further cause the user device to process the synchronization request received from the ground-based station when the space-based station is within a threshold communication distance with the ground-based station.

3. The system of claim 1, wherein the second computer-executable instructions, when executed by the second processor, further cause the user device to select between the first data log and the second data log based on the first condition and the second condition, wherein the first condition and the second condition each correspond to timestamps of log data, causal consistency between log data, semantic policies regarding log data, priority rules of log data, arithmetic operations of log data, communication capabilities of stations, location of stations, predicted location of stations according to geosynchronous orbit.

4. The system of claim 1, wherein the second computer-executable instructions, when executed by the second processor, further cause the user device to generate a data replica associated to a spacecraft, wherein the spacecraft comprises a third data store, wherein the data replica is configured to mirror data from the first and second data store.

5. The system of claim 1, wherein the second computer-executable instructions, when executed by the second processor, further cause the user device to track usage of assets corresponding to the activity with an image-based data management technique to obtain usage data of the assets.

6. A computer implemented method comprising:
under control of a user device with a processor and memory, wherein the user device is located on a first station, and wherein computer-executable instructions, when executed by the processor, cause the user device to perform steps of:
determining a type of activity performed by a user at a first station via a detection system;
generating first log data based on the determined type of activity performed by the user;
processing a synchronization request received from a second station, wherein the synchronization request includes second log data;
identifying a conflict between the first and second log data, wherein the conflict corresponds to differences of a data element value made by each the first station and the second station in respective data stores; and
in response to identifying the conflict, selecting between the first data log and the second data log as an accurate value to resolve the conflict.

7. The computer implemented method of claim 6, wherein processing the synchronization request received from the second station comprises processing the synchronization request received from the second station when the first station is within a threshold communication distance with the second station.

8. The computer implemented method of claim 6, wherein selecting between the first data log and the second data log as the accurate value to resolve the conflict comprises selecting the first log data based on a first condition or the second log data based on a second condition.

9. The computer implemented method of claim 8, wherein selecting the first log data based on a first condition or the second log data based on a second condition comprises selecting according to a data management policy the first log data based on a first condition or the second log data based on a second condition.

10. The computer implemented method of claim 6, further comprising generating a data replica associated to a third station, wherein the third station comprises a third data store, wherein the data replica is configured to mirror data from the first and second data store.

11. The computer implemented method of claim 6, wherein determining the type of activity performed by the user at the first station comprises determining the type of activity performed by the user at the first station via a sensor and determining the type of activity performed by the user at the second station via monitoring a video feed.

12. The computer implemented method of claim 6, wherein selecting between the first data log and the second data log as the accurate value to resolve the conflict comprises selecting between the first data log and the second data log as the accurate value to resolve the conflict by merging the first data log and the second data log.

13. The computer implemented method of claim 12, wherein selecting between the first data log and the second data log as the accurate value to resolve the conflict by merging the first data log and the second data log further comprises selecting between the first data log and the second data log as the accurate value to resolve the conflict by merging the first data log and the second data log according to a conflict-free replicated data type (CRDT) technique.

14. A non-transitory, computer-readable medium comprising computer-executable instructions, wherein the computer-executable instructions, when executed by a computer system, cause the computer system to:
determine a type of activity performed by a user at a first station via a detection system;
generate first log data based on the determined type of activity performed by the user;
process a synchronization request received from a second station, wherein the synchronization request includes second log data;
identify a conflict between the first and second log data, wherein the conflict corresponds to differences of a data element value made by each the first station and the second station in respective data stores;
in response to identifying the conflict, select between the first data log and the second data log as an accurate value to resolve the conflict.

15. The non-transitory, computer-readable medium of claim 14, wherein processing the synchronization request received from the second station comprises processing the synchronization request received from the second station when the first station is within a threshold communication distance with the second station.

16. The non-transitory, computer-readable medium of claim 14, wherein selecting between the first data log and the second data log as the accurate value to resolve the conflict comprises selecting the first log data based on a first condition or the second log data based on a second condition.

17. The non-transitory, computer-readable medium of claim 16, wherein selecting the first log data based on a first condition or selecting the second log data based on a second condition comprises selecting according to a data management policy the first log data based on a first condition or the second log data based on a second condition.

18. The non-transitory, computer-readable medium of claim 14, wherein the computer-executable instructions further include instructions, when executed by a computer system, cause the computer system to generate a data replica associated to a third station, wherein the third station comprises a third data store, wherein the data replica is configured to mirror data from the first and second data store.

19. The non-transitory, computer-readable medium of claim 14, wherein determining the type of activity performed by the user at the first station comprises determining the type of activity performed by the user at the first station via a sensor and determining the type of activity performed by the user at the second station via monitoring a video feed.

20. The non-transitory, computer-readable medium of claim 14, wherein selecting between the first data log and the second data log as the accurate value to resolve the conflict comprises selecting between the first data log and the second data log as the accurate value to resolve the conflict by merging the first data log and the second data log according to a conflict-free replicated data type (CRDT) technique.
